(19) United States
(12) Patent Application Publication
(10) Pub. No.: US 2008/0129894 A1
(43) Pub. Date: Jun. 5, 2008

(54) GEOMETRIC CALIBRATION APPARATUS FOR CORRECTING IMAGE DISTORTIONS ON CURVED SCREEN, AND CALIBRATION CONTROL SYSTEM AND METHOD USING THE SAME

(75) Inventors: Hyun KANG, Taejon (KR); Wook Ho SON, Taejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Taejon (KR)

(21) Appl. No.: 11/948,927

(22) Filed: Nov. 30, 2007

(30) Foreign Application Priority Data
Dec. 2, 2006 (KR) 10-2006-0121095
Sep. 13, 2007 (KR) 10-2007-0092982

(51) Int. Cl. H04N 5/74

(52) U.S. Cl. 348/758; 348/E05.137

(57) ABSTRACT

Provided are a geometric calibration apparatus for correcting image distortions of a curved screen, and a calibration control system and method using the same. In the calibration control system for correcting the image distortions of the curved screen, a high resolution camera including a pan-and-tilt controller is installed at a center portion of a front direction of a hemispherical screen in order to well correct the distortion of the images projected from multi-projectors to a hemispherical screen. The calibration control system compares a partially photographed image with a reference image to generate a new coordinate map. Therefore, an offset between unit images projected on the hemispherical screen is removed to efficiently display an extra large image.

### BACKGROUND OF THE INVENTION

1. Field of the Invention

The present invention relates to a calibration control system and method for correcting image distortions on a curved screen of a hemispherical multi-projection system, and more particularly, to a system and method that can control the matching between unit images of a curved screen and image distortions caused by the curved screen in order to achieve a single image having a high resolution and an extra large size by sequentially connecting the unit images projected from a plurality of projectors to each other using a tiled display technology.

The present invention is based on a portion of research performed in the IT New Growth Engine Core Technology Development Project, a collaborative effort of the Ministry of Information and Communication of the Republic of Korea and the Institute for Information Technology Advancement, entitled “Development of Real-Sense Type Virtual Engineering”, Filing No. 2005-S-604-02.

2. Description of the Related Art

Generally, a hemispherical multi-projection system displays a single unitary image by projecting images outputted from a plurality of projectors on a hemispherical screen.

A tiled display technology projects unit images outputted from the plurality of projectors on a single screen and then sequentially connects the plurality of unit images projected on the screen to each other to achieve a single image having a high resolution and an extra large size.

The tiled display technology can display an extra large image at a low cost beyond a current liquid crystal display (LCD) and plasma display panel (PDP) technologies that have a limitation of a screen size. In addition, the tiled display technology is used for providing 3D virtual reality, exceeding the simple concept of a monitor for displaying information to a user.

The tiled display technology is mainly used for providing the extra large image on a flat screen. Also, the tiled display technology provides the image with the high resolution and extra large size using the hemispherical screen having a hemispherical surface such that a screen viewing angles are sufficiently provided even in a narrow space using the tiled display technology.

FIG. 1 illustrates unit images projected on a hemispherical screen 100 in a rear projection type multi-projection system using the related art hemispherical screen 100.

Referring to FIG. 1, a rear projection type multi-projection system having a related art hemispherical screen includes the hemispherical screen 100 and a plurality of projectors 101 through 108.

The hemispherical screen 100 has a curved surface of a hemispherical shape. Upper and lower portions of the hemispherical screen 100 are separated from each other. The plurality of projectors 101 through 108 respectively project unit images 11 through 18 for forming a single image on the hemispherical screen 100.

Each of the unit images 11 through 18 projected from the plurality of projectors 101 through 108 is projected on a predetermined position of a rear surface of the hemispherical screen 100.

The unit images 11 through 18 are sequentially connected to each other using the tiled display technology to form a single extra large image on a front surface of the hemispherical screen 100.

FIG. 2 illustrates a portion of the unit images 11 and 13 projected by the projectors 101 and 103 on the hemispherical screen 100 in the rear projection type multi-projection system having the related art hemispherical screen 100.

A typical projector projects an image having a square shape. Referring to FIG. 2, when the image having the square shape is projected on the hemispherical screen 100, images 11 and 13 having concave shapes are displayed because light projected to an edge portion of the hemispherical screen 100 is reached more slowly than light projected to a center portion of the hemispherical screen 100.

As a result, it is difficult to match coordinates of the unit images 11 through 18 having the concave shapes, which are projected on the hemispherical screen 100. Also, it is unsuitable for forming the single extra large image because much of the unit images 11 and 13 overlaps when the unit images 11 through 18 are sequentially connected.

Many geometric calibration methods have been proposed so far in order to change the image having the concave shape into the image having the square shape.

A related art U.S. Pat. No. 6,755,537 discloses a method that can geometrically correct image distortions using a module in which an entire image of projection images projected on a flat screen is photographed using a camera and then the photographed images are analyzed. In addition, in this way, the related art U.S. Pat. No. 6,755,537 also discloses a method that can geometrically correct the image distortions even on a non-flat screen.

Accordingly, a single image is implemented by mathematically reducing an amount of light of a portion overlapped between the unit images 11 and 13 in order to solve a limitation of the portion A partially overlapped between the unit images 11 and 13 having the concave shapes. However, in that case, many pixels within the image incur a loss to correct the overlapped portion in real time.

In a rear projection type hemispherical screen, a curved surface expressed in a mathematical formula is in disagreement with a surface of an actual screen due to modification of a screen, which occurs during the fabrication of the screen. In addition, disagreement of image matching occurs according to a resolution of the used camera. Thus, a complex screen surface model is essential for mathematically and elaborately modeling the surface of the actual screen.

In a related art Korean Published Patent Application No. 10-2006-69233, a reflective mirror is used for geometrically correcting the image distortions to solve the limitations of the disagreement. However, limitations of maintenance and repair and a stable system operation occur due to the change of the physical mirror.

### SUMMARY OF THE INVENTION

Accordingly, the present invention is directed to a geometric calibration apparatus for correcting image distortions of a curved screen, and a calibration control system and method using the same, which substantially obviate one or more problems due to limitations and disadvantages of the related art.

It is an object of the present invention to provide a system, which can photograph an image projected on a hemispherical screen using a high resolution camera installed in a center portion of a front direction of the hemispherical screen and corrects coordinates of unit images such that a portion overlapped between the unit images does not occur to control correction of image distortions of a curved screen and a method using the same.

It is another object of the present invention to provide a system, which can photograph an image projected on a hemispherical screen using a high resolution camera installed at a viewing point of a user to correct image distortions due to modification of the screen that occurs during the fabrication of the screen and a method using the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a geometric calibration apparatus for correcting distortion of images projected from a plurality of projectors to a curved screen in a rear projection type multi-projection display, the geometric calibration apparatus including: a high resolution camera photographing unit images provided from the plurality of projectors to a hemispherical screen; a pan-and-tilt controller controlling the high resolution camera such that the unit images are photographed in a preset order; and a geometric calibration software execution PC including a calibration control software measuring the degree of image distortion between the unit images provided from the plurality of projectors to a hemispherical screen to correct the image distortion.

In another aspect of the present invention, there is provided a calibration control system including: a plurality of projector units including a pair of image control PCs transmitting unit images and a pair of projectors providing the unit images; a hemispherical screen displaying the unit images provided from the plurality of projector units; and a geometric calibration apparatus correcting image distortions of a curved screen to generate a new coordinate map based on a photographing result of an image projected on the hemispherical screen.

In a further another aspect of the present invention, there is provided a calibration control method using a geometric calibration apparatus for correcting distortion of images projected from projectors in a multi-projection display having a rear projection type hemispherical screen, the calibration control method including: setting a right upper surface of a front surface of the hemispherical screen as a reference screen, and an image projected on the reference screen as a reference image; determining a calibration order of remaining images except the reference image; partially photographing the remaining images using a high resolution camera in pre-determined order; comparing the partially photographed images with the previously stored reference image to measure the degree of image distortion and calculate a calibration value based on the measured degree of the image distortion; applying the calculated calibration value and recalculating coordinate maps of the partially photographed images to generate a new coordinate map; and changing positions of the projectors using the new coordinate map to correct the image distortion.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates unit images projected on a hemispherical screen in a rear projection type multi-projection system using a related art hemispherical screen;

FIG. 2 illustrates a portion of the unit images projected on the hemispherical screen in the rear projection type multi-projection system of FIG. 1;

FIG. 3 schematically illustrates a configuration of a calibration control system for correcting image distortions of a curved screen in order to control correction of image distortions projected on a hemispherical screen according to the present invention;

FIG. 4 illustrates a block diagram of a calibration control unit for correcting image distortions of a curved screen according to the present invention; and

FIG. 5 illustrates a flowchart of a method for controlling correction of image distortions projected on a hemispherical screen in a calibration control system for correcting image distortions of a curved screen according to the present invention.

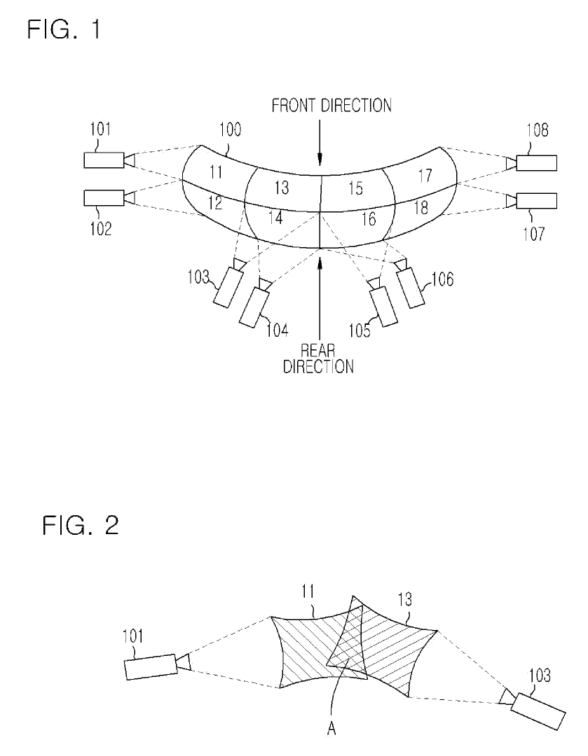

### DETAILED DESCRIPTION OF THE INVENTION

Reference will now be made in detail to the preferred embodiments of the present invention, examples of which are illustrated in the accompanying drawings. In the following description, well-known functions or constructions are not described in detail since they would obscure the invention in unnecessary detail.

FIG. 3 schematically illustrates a configuration of a calibration control system for correcting image distortions of a curved screen in order to control distortion of images projected on a hemispherical screen according to the present invention.

Referring to FIG. 3, a calibration control system using a geometric calibration apparatus for correcting image distortions of a curved screen includes a plurality of projectors 401 through 404 of a rear projection type, a hemispherical screen 400, an image control personal computers (PCs) 201 through 204, a high resolution camera 300, a pan-and-tilt controller 301, and a PC 302 capable of executing geometric calibration S/W (hereinafter, refer to as “a geometric calibration S/W execution PC”).

The calibration control system uses a tiled display technology in which a plurality of unit images are sequentially connected to each other to form a single extra large image on a hemispherical screen 400.

The unit images of each of projectors 401 through 404 are projected on corresponding portions of the hemispherical screen 400, respectively. Positioners 411 through 414 respectively installed at he projectors 401 through 404 adjust directions of the projectors 401 through 404 to project the unit images on the corresponding portions of the hemispherical screen 400.

In general, the unit image outputted from the projector is a square-shaped image. However, since the unit image is projected on the hemispherical screen as illustrated in FIG. 2, the projected image is changed into a concave shape.

Hence, in order to correct the image distortions of the curved screen, an entire image projected on the hemispherical screen 400 is partially photographed using a high resolution camera 300 to perform geometric calibration of the image.

The geometric calibration is to project line vectors of geometric calibration patterns generated from the image control PCs 201 through 204 through the plurality of projectors 401 through 404 to sequentially display the unit images on an entire screen. A geometric calibration pattern images are images in which a configuration of the hemispherical screen 400 is mathematically calculated to indicate coordinates of portions of the entire screen.

The image control PCs 201 through 204 respectively connected to the projectors 401 through 404 generate the geometric calibration pattern image to project the generated geometric calibration pattern image on the hemispherical screen 400 through each of the projectors 401 through 404.

As illustrated in FIG. 2, however, the line vectors of the geometric calibration pattern images of each of the projectors 401 through 404 are not continued or are overlapped due to an error between the configuration of the hemispherical screen 400 and existing parameters of the geometric calibration pattern images.

The geometric calibration pattern images projected on the hemispherical screen 400 are partially photographed using the high resolution camera 300 instead of a user's sight in order preset by the pan-and-tilt controller 301 when the geometric calibration pattern images are projected from the plurality of projectors 401 through 404, respectively. A calibration control unit 310 detects whether the line vectors of the partially photographed geometric calibration pattern images are straight lines or curved lines of a quadratic function.

The pan-and-tilt controller 301 controls movement of the high resolution camera 300 such that the unit images projected from the plurality of projectors 401 through 404 to the hemispherical screen 400 are partially photographed in order preset by the pan-and-tilt controller 301. It is preferable that the high resolution camera having a resolution of over about ten million pixels is used for precisely photographing an image such that the error of the entire hemispherical screen is precisely corrected.

The geometric calibration S/W execution PC 302 includes the calibration control unit 310 operated by the geometric calibration S/W. The calibration control unit 310 analyzes a relationship between the geometric calibration pattern images projected form the plurality of projectors 401 through 404 and previously stored photographed images to control correction of the image distortions of the curved screen.

The high resolution camera 300 partially photographs the unit images from a reference screen, e.g., a right side of an upper portion of the screen, for image correction to adjacent unit images in order preset by the pan-and-tilt controller 301.

The calibration control unit 310 changes a coordinate map of the projector projecting an adjacent unit image to generate a new coordinate map such that an arrangement of lines of the adjacent unit images that are partially photographed based on lines of the geometric calibration pattern images projected on a screen, which is the reference screen for the image correction, thereby controlling the image distortions of the curved screen.

The image correction of the curved screen by a change of the coordinate map may be frequently performed whenever the image distortions occur between the unit images projected on the hemispherical screen 400.

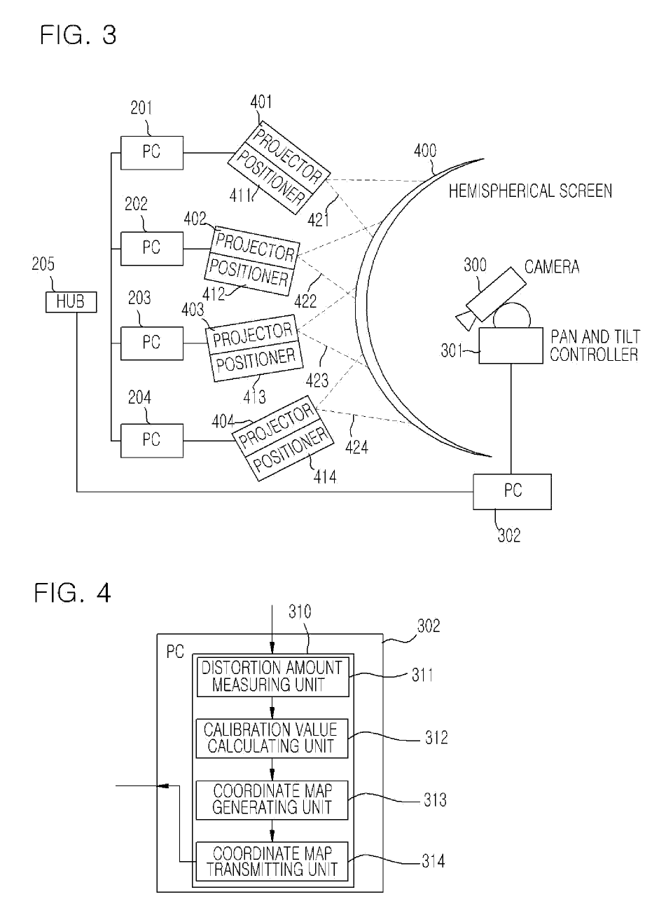

FIG. 4 illustrates a block diagram of a calibration control unit 310 for correcting image distortions of a curved screen according to the present invention.

The calibration control unit 310 includes a distortion amount measuring unit 311, a calibration value calculating unit 312, a coordinate map generating unit 313, and a coordinate map transmitting unit 314. The calibration control unit 310 receives unit images partially photographed using a high resolution camera 300 to perform geometric calibration.

The high resolution camera 300 photographs an unit image of a reference screen, e.g., a right side of an upper portion of a front screen, to store a geometric calibration S/W execution PC 302. Then, the high resolution camera 300 partially photographs the unit images such that about 2-4 unit images projected on a hemispherical screen 400 are included.

The distortion amount measuring unit 311 measures a degree of distortion of lines of geometric calibration patterns indicated between a unit image of a previously stored reference screen and a partially photographed image. That is, the distortion amount measuring unit 311 measures the degree of the distortion, i.e., an offset degree between the geometric calibration pattern lines of the unit images that are projected on the hemispherical screen 400 and picked from the high resolution camera 300.

The distortion amount measuring unit 311 may measure the degree of the distortion using a manually input estimate after measuring the degree of the distortion by detecting an offset of the unit image through the naked eye of a manager.

The calibration value calculating unit 312 calculates a calibration value based on the degree of the distortion of the measured unit image. The calibration value calculating unit 312 compares a rotation and scaling of an upper and lower line of the geometric calibration pattern image with a rotation and scaling of a line of an adjacent pattern image to calculate a calibration value suitable to geometric calibration patterns of the reference screen.

The coordinate map generating unit 313 recalculates the coordinate of the offset unit image based on the calculated calibration value. A rotation and scaling of outlines of pattern image are generated according to the calibration value of the calibration value calculating unit 312. Hence, the coordinate map is updated through affine-transforming the rotation and scaling of the outlines to an entire map.

The coordinate map transmitting unit 314 transmits the generated coordinate map to image control PCs 201 through 204 through a hub 205. The image control PCs 201 through 204 controls such that positioners 411 through 414 moves projectors 401 through 404 according to the transmitted new coordinate map to project the projected unit image on a screen corresponding to a calibrated coordinate.

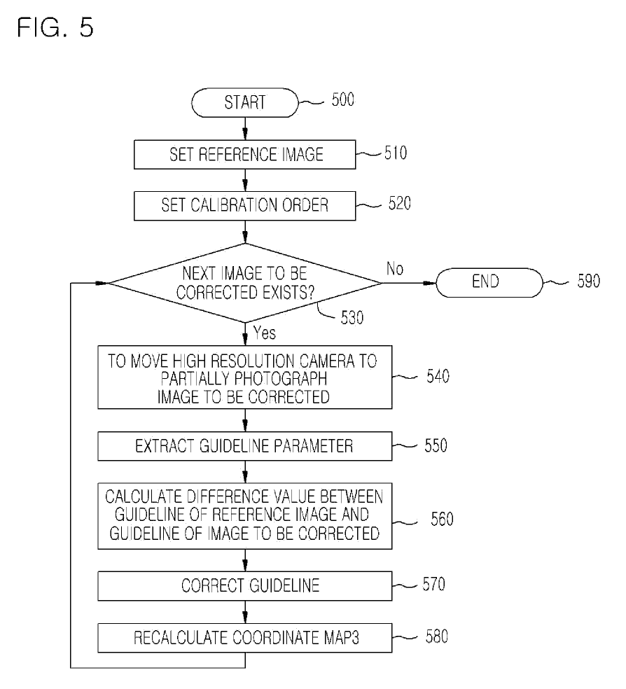

FIG. 5 illustrates a flowchart of a method for controlling distortion of images projected on a hemispherical screen in a calibration control system for correcting image distortions of a curved screen according to the present invention.

Referring to FIG. 5, when a system starts in step 500, there is determined that one reference screen for calibration of a plurality of unit images projected on a hemispherical screen 400. In general, a right upper surface of a front surface of the hemispherical screen 400 is set as the reference screen, and an image projected on the reference screen is set as a reference image in step 510.

After the reference image is determined in step 510, a perpendicularity and horizontality of projectors are measured using a laser level, and at the same time, a position and posture of projectors is manually corrected.

In step 520, a calibration order of remaining images is determined and stored. The calibration order starts from an image engaged with the reference image.

Image distortions are corrected by repeatedly performing geometric calibration until calibration operations for entire images are finished according to the determined calibration order as the following steps 530 through 580.

In particular, in the image correction processes, a geometric calibration S/W execution PC 302 determines whether a next image to be corrected exists in step 530. If yes in step 530, a partial image including two through four unit images projected from the projectors is photographed using a high resolution camera 300 to receive the photographed image data in step 540. The received image data is stored in a memory (not shown) of the geometric calibration S/W execution PC 302. If no in step 530, the system is ended.

The geometric calibration S/W execution PC 302 moves the high resolution camera 300 precisely installed at a viewing point of a user in a center portion of a front direction of the hemispherical screen 400 using a pan-and-tilt controller 301 in the calibration order set from the reference image.

The projectors projecting image to be corrected provides geometric calibration pattern images. The geometric calibration pattern images are an image formed by lines having predetermined distance generated through image control PCs 201 through 204. The high resolution camera 300 photographs such geometric calibration pattern images.

A distortion amount measuring unit 311 analyzes a relationship between geometric calibration patterns of the image to be corrected photographed by the high resolution camera 300 and geometric calibration patterns of the reference image previously stored in the geometric calibration S/W execution PC 302 to measure the degree of the image distortion.

In particular, lines, that disagree, to be corrected may be extracted by comparing geometric calibration pattern lines of the photographed image to be corrected with geometric calibration pattern lines of the reference image. In step 550, the geometric calibration pattern lines are guidelines and are extracted by a computer vision algorithm such as Binary operation, Morphologic operation, and Hough transform operation.

In step 560, the degree of the image distortion is measured by comparing a parameter between a guideline of the extracted reference image with a guideline of the image to be corrected. A calibration parameter is determined using the measured degree of the image distortion.

In step 570, the guideline of the image to be corrected is corrected based on the determined calibration parameter. In step 580, a coordinate map of the image to be corrected is recalculated based on the corrected guideline.

The recalculated coordinate map information is transmitted to image control PCs 201 through 204 through a hub 205. The image control PCs 201 through 204 controls each of positioners 411 through 414 to move each of projectors 401 through 404 and control such that the image to be corrected is projected on a predetermined screen corresponding to the recalculated coordinate map.

It will be apparent to those skilled in the art that various modifications and variations can be made in the present invention. Thus, it is intended that the present invention covers the modifications and variations of this invention provided they come within the scope of the appended claims and their equivalents.

1. A geometric calibration apparatus for correcting distortion of images projected from a plurality of projectors to a curved screen in a rear projection type multi-projection display, the apparatus comprising:
a high resolution camera photographing unit images provided from the plurality of projectors to a hemispherical screen;
a pan-and-tilt controller controlling the high resolution camera such that the unit images are photographed in a preset order; and
a geometric calibration software execution PC including a calibration control software for measuring the degree of image distortion between the unit images provided from the plurality of projectors to the hemispherical screen to correct the image distortion.

2. The apparatus of claim 1, wherein the high resolution camera partially photographs the unit images of the plurality of projectors from a reference screen in the preset order.

3. The apparatus of claim 1, wherein the pan-and-tilt controller is installed at a viewing point of a user in a center portion of a front direction of the hemispherical screen.

4. The apparatus of claim 1, wherein the calibration control software performs camera geometric calibration on the distorted image.

5. The apparatus of claim 4, wherein the calibration control software measures the degree of the image distortion of the photographed unit images, calculates a calibration value based on the measured degree of the image distortion such that the unit images are not overlapped, and applies the calculated calibration value to generate a new coordinate map of the unit images.

6. The apparatus of claim 5, wherein the calibration control software analyzes a relationship between a geometric calibration pattern image and a previously stored and photographed image.

7. The apparatus of claim 6, wherein the geometric calibration pattern image comprises a plurality of white lines regularly arranged on a black ground.

8. The apparatus of claim 6, wherein the calibration control software measures the degree of the image distortion between line vectors of geometric calibration patterns of each of projectors and a parameter of straight lines and curved lines of a quadratic function.

9. The apparatus of claim 1, wherein the multi-projection system comprises a rear projection type tiled display that sequentially connects the plurality of unit images on the hemispherical screen to achieve a single extra large image.

10. A calibration control system comprising:
a plurality of projector units including a pair of image control PCs transmitting unit images and a pair of projectors providing the unit images;
a hemispherical screen displaying the unit images provided from the plurality of projector units; and
a geometric calibration apparatus correcting image distortions of a curved screen to generate a new coordinate map based on a photographing result of an image projected on the hemispherical screen.

11. The calibration control system of claim 10, wherein the image control PCs generate a geometric calibration pattern image to the projectors.

12. The calibration control system of claim 10, wherein the plurality of projector units further comprises positioners moving the projectors according to a new coordinate map transmitted form the geometric calibration apparatus.

13. The calibration control system of claim 10, wherein the geometric calibration apparatus comprises:
a camera partially photographing the image projected on the hemispherical screen;
a pan-and-tilt controller controlling a position of the high resolution camera such that unit image on the hemispherical screen are partially photographed in a preset order; and
a geometric calibration software execution PC comparing the geometric calibration pattern image with the partially photographed image, extracting straight lines and curved lines of a quadratic function, and measuring the degree of the image distortion to change a coordinate map of the partially photographed image.

14. The calibration control system of claim 13, wherein the geometric calibration software execution PC changes a coordinate map in real time according to a calibration value based on the degree of the image distortion of the unit images projected from each of projectors.

15. A calibration control method using a geometric calibration apparatus for correcting distortion of images projected from projectors in a multi-projection display having a rear projection type hemispherical screen, the calibration control method comprising:
setting a right upper surface of a front surface of the hemispherical screen as a reference screen, and an image projected on the reference screen as a reference image;
determining a calibration order of remaining images except the reference image;
partially photographing the remaining images using a high resolution camera in pre-determined order;
comparing the partially photographed images with the previously stored reference image to measure the degree of image distortion and calculate a calibration value based on the measured degree of the image distortion;
applying the calculated calibration value and recalculating coordinate maps of the partially photographed images to generate a new coordinate map; and
changing positions of the projectors using the new coordinate map to correct the image distortion.

16. The calibration control method of claim 15, wherein the partially photographing of the remaining images comprises photographing of adjacent images in the calibration order set from the reference image.

17. The calibration control method of claim 15, wherein the measuring of the degree of the image distortion comprises measuring an offset degree of lines that disagree by comparing geometric calibration pattern lines of the partially photographed image with geometric calibration pattern lines of the reference image.

18. The apparatus of claim 1, wherein the calibration control software measures the degree of the image distortion of the photographed unit images, calculates a calibration value based on the measured degree of the image distortion such that the unit images are not overlapped, and applies the calculated calibration value to generate a new coordinate map of the unit images.

19. The apparatus of claim 18, wherein the calibration control software analyzes a relationship between a geometric calibration pattern image and a previously stored and photographed image.
